(19) United States
(12) Patent Application Publication
(10) Pub. No.: US 2013/0115385 A1
(43) Pub. Date: May 9, 2013

(54) METHOD FOR MANUFACTURING COLOR FILTER SUBSTRATE

(71) Applicants: Yoshitaka Okumoto, Osaka (JP); Yusuke Waratani, Osaka (JP); Keiichi Tanaka, Osaka (JP); Kazuki Kobayashi, Osaka (JP)

(72) Inventors: Yoshitaka Okumoto, Osaka (JP); Yusuke Waratani, Osaka (JP); Keiichi Tanaka, Osaka (JP); Kazuki Kobayashi, Osaka (JP)

(73) Assignee: SHARP KABUSHIKI KAISHA, Osaka (JP)

(21) Appl. No.: 13/809,649

(22) PCT Filed: Apr. 13, 2011
(86) PCT No.: PCT/JP2011/059197

§ 371 Date: Jan. 11, 2013

(30) Foreign Application Priority Data
Jul. 14, 2010 (JP) 2010-159911

(51) Int. Cl. B05D 5/06

(52) U.S. Cl. CPC B05D 5/06
USPC 427/555; 427/162

(57) ABSTRACT

The present invention provides a method for manufacturing a color filter substrate, in which the occurrence of color mixing between adjacent sub-pixels is prevented even when an inkjet method is used. A color filter substrate having color filters of a plurality of colors arranged in a matrix with a bank therebetween is manufactured using this method. The method has: a first inkjet step in which an ink is jetted to at least one region among a plurality of regions partitioned by the bank, and the ink is not jetted to any of regions adjacent to the one region in the horizontal direction and the vertical direction; and a second inkjet step in which the ink is jetted to at least one region to which the ink has not been jetted in the first inkjet step, the aforementioned at least one region being among the plurality of regions partitioned by the bank.

### TECHNICAL FIELD

The present invention relates to a method for manufacturing a color filter substrate, and more particularly, to a method for manufacturing a color filter substrate that includes steps of forming a color filter by the inkjet process.

### BACKGROUND ART

A color filter substrate is generally configured by placing color filters of a plurality of colors on a substrate such as a glass substrate in a systematic manner. The most common combination of color filter colors for each pixel, which is the smallest unit for conducting color display, are the three primary colors of red (R), green (G), and blue (B).

The photolithography process is the main process used in manufacturing color filters, but this requires the steps of coating, exposure, developing, and baking to be conducted the same number of times as the number of colors in order to form the color layers.

By contrast, in the inkjet process, an inkjet device is equipped with a plurality of heads, and each of the plurality of heads discharges an ink of a different color, which allows layers of different colors to be formed in one step, thus shortening the whole process. Also, in the inkjet process, it is possible for the ink to be discharged only onto necessary locations, which removes the need for the steps of exposure and developing.

Conventional improved examples that use the inkjet process include a technique by which the spacing and position of a plurality of ink discharge nozzles are controlled under fixed conditions according to pixel spacing and corresponding color pixels are colored (refer to Patent Document 1, for example), a technique by which a coloring region is scanned by inkjet heads and ink discharge is conducted a plurality of times (refer to Patent Document 2, for example), and a technique that repeats the following two steps when forming colored layers: a coating step using the inkjet method; and a temporary curing step in which temporary curing is conducted on a coating liquid (refer to Patent Document 3, for example).

### RELATED ART DOCUMENTS

### Patent Documents

Patent Document 1: Japanese Patent Application Laid-Open Publication No. H9-138306

Patent Document 2: Japanese Patent Application Laid-Open Publication No. 2003-232912

Patent Document 3: Japanese Patent Application Laid-Open Publication No. 2008-89896

### SUMMARY OF THE INVENTION

### Problems to be Solved by the Invention

The inventors of the present invention have conducted various studies on methods for forming color filters by the inkjet method, and have found that when forming color filters by discharging ink into regions partitioned into specific areas (also referred to as sub-pixel opening regions below) by partitions (also referred to as a bank below), color mixing occurs in parts of adjacent color filters of different colors in some cases, which prevents the color filters from being formed according to design.

Such a phenomenon often occurs when respective different color inks are discharged continuously into the plurality of sub-pixel opening regions in one step, and accounts for approximately 50% to 70% of all defects in the process of forming the color filters.

Also, the inventors of the present invention have found that when respective different colored inks are discharged into the plurality of sub-pixel opening regions in one step, the discharged ink tends to gather in the center of each sub-pixel opening region, which means that the thickness of the color filters is greatest in the center of the sub-pixels, and the color filters tend to be thinner towards the edge of the sub-pixels.

FIGS. 16 and 17 are schematic plan views that show color filters when different color inks are discharged into the respective plurality of sub-pixel opening regions in one step. FIG. 16 shows the configuration a color filter in one sub-pixel, and FIG. 17 shows the configuration of color filters in one pixel. In the present specification, one pixel is constituted of a combination of a plurality of sub-pixels.

In FIG. 17, one pixel is constituted of a combination of three color filters: a red (R) color filter 31R, a green (G) color filter 31G, and a blue (B) color filter 31B. Also, each color filter 31 is surrounded by a bank 32. The ellipses in FIGS. 16 and 17 schematically show the difference in thickness within each color filter.

As shown in FIGS. 16 and 17, each color filter is thicker towards the center of a sub-pixel and thinner towards the edge of a sub-pixel. As a result, if each sub-pixel is rectangular, a gentle incline is formed from the center of the sub-pixel to the shorter sides of the edge, and a steep incline is formed from the center of the sub-pixel to the longer sides of the edge. Such a variation in film thickness results in light leaking from the thin regions, for example, and thus, such a shape is not preferable.

FIG. 18 is a schematic plan view that shows a color filter in which color mixing has occurred as a result of different color inks being discharged into the respective plurality of sub-pixel opening regions in one step. If the green ink and the blue ink come into contact, the surface tension of each of the inks causes the inks to become one liquid drop, and as a result, as shown in FIG. 18, a color filter 91 in which color mixing has occurred is formed in some cases. Such parts where color mixing has occurred are defective, which means a desired color balance cannot be attained.

The inventors of the present invention have conducted various studies on how to remove such defects resulting from color mixing and have attempted to use a laser to remove the defective parts and to discharge ink again therein. FIG. 19 is a schematic plan view that shows a configuration of color filters in one pixel when the parts where color mixing has occurred are removed by laser. FIG. 20 is a schematic plan view that shows a configuration of color filters in one pixel when ink is discharged again after the removal step by laser.

As shown in FIG. 19, by using a laser, most of the defective parts can be removed, but the vicinity of the edge of the sub-pixel cannot be completely removed, which results in a remaining margin 92 being left over. In other words, it is not possible to have the shape of the opening formed by the laser to be completely the same as the shape of the sub-pixel (the region surrounded by the bank 32). Thus, while it is possible to repair the defect to a certain extent by removing the ink using a laser and discharging ink therein again, as shown in FIG. 20, parts where the color is mixed with the remaining margin 92 stand out, which means that the defect is not repaired to a sufficient degree.

The present invention takes into consideration the above-mentioned situation, and an object thereof is to provide a method for manufacturing a color filter substrate that can prevent the occurrence of color mixing between adjacent sub-pixels even when the inkjet method is used.

### Means for Solving the Problems

The inventors of the present invention have conducted various studies on how to remove defects resulting from color mixing and noticed that color mixing occurred when ink was discharged into the plurality of sub-pixel opening regions in one step, and have thus attempted a method in which inkjet drawing is conducted in two steps. Specifically, inkjet drawing was conducted such that when one drawing region was set, ink was not discharged in the same step in drawing regions adjacent to the aforementioned drawing region, and after ink was discharged in the one drawing region, ink was discharged in drawing regions adjacent to regions where ink discharge has already been conducted, such that adjacent color filters were formed at different times.

FIG. 21 is a schematic plan view that shows one example of color filters in which after inkjet discharge is conducted in one sub-pixel opening region out of adjacent sub-pixel opening regions of the same color, inkjet discharge is conducted continuously in the other sub-pixel opening regions. As shown in FIG. 21, in the respective sub-pixel opening regions, color filters of different colors are formed with a bank 72 interposed therebetween. The colors of the color filters are red, green, and blue, and the red (R) color filter 71R, the green (G) color filter 71G, and the blue (B) color filter 71B are each partitioned by a bank 72.

However, even if the inkjet drawing is divided into two steps, color mixing defects occurred between some adjacent sub-pixel opening regions. As shown in FIG. 21, color mixing parts 61 are formed between the red (R) color filter 71R and the blue (B) color filter 71B, and between the blue color filter 71B and the green color filter 71G.

Upon detailed study concerning causes of the color mixing, the inventors of the present invention were able to find that the causes of the color mixing include the following.

The first cause is that in the first ink drawing step, when the ink lands on the substrate, some of the ink rises onto the bank, and the ink that has risen onto the bank flows into empty sub-pixel opening regions, and ink that fills those regions in the second ink drawing step flows onto the previous ink, which results in the inks mixing, causing the colors to mix.

The second cause is that in the second ink drawing step, some of the ink rises onto the bank and the ink that has risen onto the bank flows into adjacent sub-pixel opening regions, and mixes with ink that has been drawn in the first step, causing mixing. It is preferable that a liquid-repellence treatment be conducted on the surface of the bank such that ink is contained within the region surrounded by the bank before the first ink drawing step is conducted. However, even in such a case, some of the ink drawn in the first step volatilizes after landing on the substrate, which reduces the liquid-repellence of the surrounding bank. Therefore, even if liquid-repellence treatment is conducted in advance, ink drawn during the second step is not retained within the sub-pixel opening region and rises onto the bank, and flows into adjacent sub-pixel opening regions, thus causing color mixing.

The inventors of the present invention have conducted diligent studies on methods to solve these problems, and have focused on adding a drying step between the first drawing step and the second drawing step. The inventors of the present invention have found that by drying the ink sufficiently in the drying step conducted after the first ink drawing step is conducted, it is possible to prevent the inks from mixing even when the second ink drawing step is conducted, thus reducing the effect of color mixing.

Also, the inventors of the present invention have, upon considering other methods to solve the above-mentioned problem, focused on conducting liquid-repellence treatment on the surface of the bank between the first drawing step and the second drawing step. The inventors of the present invention have found that by providing sufficient liquid-repellence to the bank by the liquid-repellence treatment after conducting the first ink drawing step, it is possible to prevent the ink from the second ink drawing step from rising onto the bank, thus preventing color mixing.

In addition, the inventors of the present invention have focused on minimizing the possibility of ink mixing before drying by having all regions adjacent to where ink is to be discharged be empty regions when conducting the first drawing step. As a result, even if ink flows into the adjacent empty regions, it is possible to repair this defect by the drying step and a laser step. Also, the inventors of the present invention have, upon conducting ink drawing using such a method and conducting detailed analysis, found that the color filter that is formed is more flat.

As stated above, when ink is discharged into adjacent sub-pixel opening regions in one step, the ink that has landed on the substrate gathers towards the center of the sub-pixel due to surface tension, which causes the shape thereof to change to a substantially hemispherical shape or a substantially dome shape. As a result, unevenness in the thickness of the ink occurs and ink does not sufficiently spread throughout the region defined by the bank, which results, in some cases, in light leaking through. In particular, if the sub-pixel is formed in a substantially rectangular shape, the ink often does not sufficiently spread to the four corners of the sub-pixel. Also, even if light leakage does not occur, there is a possibility that the color purity would deteriorate.

By contrast, if the first discharge step is conducted such that all regions adjacent to the region where ink is to be discharged are empty regions, the ink that has landed on the substrate is pulled towards the empty regions due to surface tension. As a result, the surface of the ink becomes flat, and even if the sub-pixel is formed into a substantially rectangular shape, it is possible to have the ink sufficiently spread to the four corners of the sub-pixel with ease.

FIGS. 22 and 23 are schematic plan views that show an example of color filters that are formed by conducting inkjet discharge of ink into one sub-pixel opening region out of adjacent sub-pixel opening regions of the same color such that different color inks are drawn to form a checkered pattern, drying the ink from the first drawing step by conducting a drying step, and then conducting inkjet discharge of ink in the other sub-pixel opening regions. FIG. 22 shows a situation in which the first drawing step has been conducted, and FIG. 23 shows a situation in which the second drawing step has been conducted. As shown in FIGS. 22 and 23, color mixing defects do not occur between the adjacent blue color filter 81B and the green color filter 81G, between the adjacent blue color filter 81B and the red color filter 81R, or between the adjacent green color filter 81G and the red color filter 81R. It was found that by having regions adjacent to where the first drawing step is conducted be empty regions, conducting a drying step after the first drawing step and drying the ink to a sufficient degree, and then conducting the second drawing step as stated above, the occurrence of color mixing can be effectively mitigated.

When comparing FIGS. 22 and 23, the degree to which ink discharged in the inkjet drawing step rises onto the bank 82 is greater in the regions where the second drawing step is conducted compared to the regions where the first drawing step is conducted. This indicates that when the first inkjet drawing step is conducted, the liquid-repellence of the surface of the bank 82 located in the edge has decreased. Thus, by conducting a liquid-repellence treatment on the surface of the bank 82 after finishing the first inkjet step, it is possible to prevent ink from the second inkjet step from rising onto the bank 82, which greatly reduces the possibility of color mixing.

In this manner, the inventors of the present invention have been able to solve the above-mentioned problems and have arrived at the present invention.

In other words, one aspect of the present invention is a manufacturing method (also referred to as the first manufacturing method of the present invention) for a color filter substrate that has color filters of a plurality of colors arranged in a matrix with a bank therebetween, including: a first inkjet step in which ink is discharged to at least one region of a plurality of regions partitioned by the bank, and in which ink is not discharged to any region adjacent to the aforementioned at least one region in the horizontal direction or the vertical direction; and a second inkjet step in which ink is discharged to at least one region out of the plurality of regions partitioned by the bank where ink was not discharged in the first inkjet step.

Another aspect of the present invention is a manufacturing method (also referred to as the second manufacturing method of the present invention) for a color filter substrate that has color filters of a plurality of colors arranged in a matrix with a bank therebetween, including: a first inkjet step in which ink is discharged to at least one region of a plurality of regions partitioned by the bank; a drying step in which ink is dried after the first inkjet step; and a second inkjet step in which ink is discharged to at least one region out of the plurality of regions partitioned by the bank where ink was not discharged in the first inkjet step.

In addition, another aspect of the present invention is a manufacturing method (also referred to as the third manufacturing method of the present invention) for a color filter substrate that has color filters of a plurality of colors arranged in a matrix with a bank therebetween, including: a first inkjet step in which ink is discharged to at least one region of a plurality of regions partitioned by the bank; a liquid-repellence step in which liquid-repellence treatment is conducted on a surface of the bank that surrounds the ink after the first inkjet step; and a second inkjet step in which ink is discharged to at least one region out of the plurality of regions partitioned by the bank where ink was not discharged in the first inkjet step.

Color filter substrates manufactured by the first to third manufacturing methods of the present invention have color filters of a plurality of colors arranged in a matrix with a bank therebetween. More specifically, examples of a configuration of a color filter substrate includes a configuration in which a bank, which is patterned in a prescribed shape, and color filters are disposed on a support substrate made of a material such as glass or resin.

The first to third manufacturing methods of the present invention have a first inkjet step in which ink is discharged in at least one of a plurality of regions partitioned by the bank, and a second inkjet step in which ink is discharged in at least one region where ink was not discharged in the first inkjet step. In other words, in the manufacturing methods of the present invention, the color filters are formed by the inkjet method. As long as there are at least two inkjet steps, the number of inkjet steps is not limited.

In the first manufacturing method of the present invention, in the first inkjet step, ink is not discharged to any region adjacent to the above-mentioned at least one region in the horizontal direction or the vertical direction. As a result, ink spreads evenly within the sub-pixel opening region, thus flattening the surface of the ink, which allows a color filter that is not susceptible to light leakage to be attained. Also, a decrease in color purity can be mitigated compared to a case in which there are major variations in film thickness.

In the first manufacturing method of the present invention, from the perspective of making the manufacturing steps more efficient, it is preferable that a region where the second inkjet step is conducted be at least one region adjacent to a region where the first inkjet step is conducted. Also, it is preferable that the first inkjet step be a step in which ink is discharged in a checkered pattern. In addition, it is preferable that the second inkjet step be a step in which ink is discharged in a checkered pattern. As a result, ink is discharged to all sub-pixel opening regions in at least two inkjet steps. If the inkjet step is conducted so as to form a checkered pattern, pattern films having a cross-sectional shape similar to each other tend to be formed in the checkered pattern. This is because, for example, the thermal history of the substrate on which the ink lands differs as a result of heat-drying conducted after the first drawing step, or volatile components of the ink that has landed on the substrate in the first drawing step enter a sub-pixel opening region where the second drawing step is to be conducted, which causes the wettability of the ink drawn in the second step to differ. Also, the cross-sectional shape of the ink greatly depends on the physical properties of the ink, but differences in cross-sectional shape are more pronounced among same color inks.

The second manufacturing method of the present invention includes, between the first inkjet step and the second inkjet step, a drying step of drying the ink after the first inkjet step. In the present invention, steps in which the ink is dried until the fluidity thereof is gone such as heat treatment and vacuum drying are included in the definition of a “drying step,” and a case in which only natural drying is conducted is not included. It is preferable that the drying step be a step of applying heat to polymerize the materials included in the ink. Such a step is made possible by including compounds in the ink that are induced to have a polymerization reaction when heated, and this polymerization step allows drying to take place to a sufficient degree.

In the second manufacturing method of the present invention, even if the color of inks discharged in adjacent regions differ from each other and one of the inks flows onto the other ink (after drying), the inks themselves do not mix, and thus a deterioration in visibility due to color and brightness differences is prevented.

The third manufacturing method of the present invention includes, between the first inkjet step and the second inkjet step, a liquid-repellence step of conducting a liquid-repellence treatment on the surface of the bank, which surrounds the ink after the first inkjet step. By conducting liquid-repellence treatment on the surface of the bank before conducting the inkjet step, the discharged ink can be effectively kept within the region surrounded by the bank. If a plurality of discharge steps are to be performed, the ink discharged in the first discharge step volatilizes and weakens the liquid-repellence of the bank, which makes the liquid-repellence treatment before the second inkjet step particularly effective. One method for conducting the liquid-repellence treatment is a plasma treatment that uses a fluorine-containing plasma or the like.

According to the third manufacturing method of the present invention, it is possible to prevent the ink from rising onto the bank and flowing into an adjacent sub-pixel, and thus, the possibility of color mixing can be effectively mitigated.

As long as the first to third manufacturing methods of the present invention include the above-mentioned constituting steps as necessary steps, there is no particular limitation on other constituting steps.

Also, it is more preferable that the first to third manufacturing methods of the present invention be appropriately combined. As a result, the effect of preventing color mixing can be attained to an even greater degree.

In other words, it is preferable that the first manufacturing method of the present invention include, between the first inkjet step and the second inkjet step, a drying step of drying the ink after the first inkjet step. Also, it is preferable that a liquid-repellence step of conducting a liquid-repellence treatment on the surface of the bank be included between the first inkjet step and the second inkjet step.

In the second manufacturing method of the present invention, it is preferable that the first inkjet step be a step in which ink is not discharged to any region adjacent to the above-mentioned at least one region in the horizontal direction or the vertical direction. Also, it is preferable that a liquid-repellence step of conducting a liquid-repellence treatment on a surface of the bank be included between the first inkjet step and the second inkjet step.

In addition, in the third manufacturing method of the present invention, it is preferable that the first inkjet step be a step in which ink is not discharged to any region adjacent to the above-mentioned at least one region in the horizontal direction or the vertical direction. Also, it is preferable that a drying step of drying the ink after the first inkjet step be included between the first inkjet step and the second inkjet step.

Preferred embodiments of manufacturing methods for the color filter substrate according to the present invention will be described in further detail.

It is preferable that the above-mentioned manufacturing method include, between the first inkjet step and the second inkjet step, a repair step of removing the ink by laser after the first inkjet step. Even when using the manufacturing methods of the present invention, there is a possibility that ink flows into sub-pixels adjacent to the sub-pixel where the inkjet step is conducted. In such a case, color mixing can be prevented by removing ink of a color deviating from the design using a laser.

It is preferable that a transmittance of a color of a color filter formed in the first inkjet step be less than a transmittance of a color of a color filter formed in the second inkjet step. This is because, if the transmittance of the color of the color filter formed in the first inkjet step is greater than the transmittance of the color of the color filter formed in the second inkjet step, then any color mixing that occurs stands out compared to a case in which the transmittance of the color of the color filter formed in the first inkjet step is less than the transmittance of the color of the color filter formed in the second inkjet step. For example, if one pixel is constituted of six colors where the colors in order of greatest to least transmittance are yellow, green, cyan, red, magenta, and blue, then it is preferable that the red, magenta, and blue sub-pixels, which have a relatively low transmittance, be formed in the first inkjet step, and that the yellow, cyan, and green sub-pixels, which have a relatively high transmittance, be formed in the second inkjet step.

It is preferable that the above-mentioned manufacturing method include a hydrophilic step of conducting hydrophilic treatment on a surface where ink is to land before the second inkjet step. By conducting hydrophilic treatment on the surface on which the ink lands, the ink sticks more readily to the surface where it lands, which prevents the ink from flowing into adjacent regions.

### Effects of the Invention

According to a manufacturing method of a color filter substrate of the present invention, it is possible to prevent color mixing between adjacent sub-pixels even when using the inkjet method.

### BRIEF DESCRIPTION OF THE DRAWINGS

FIG. 1 is a schematic plan view that shows the position of colors in a color filter substrate of Embodiment 1.

FIG. 2 is a schematic plan view that shows a first drawing pattern for when the color filter substrate of Embodiment 1 is manufactured.

FIG. 3 is a schematic plan view that shows a second drawing pattern for when the color filter substrate of Embodiment 1 is manufactured.

FIG. 4 is a schematic plan view that shows contour lines of color filters provided on a color filter substrate of Comparison Example 1.

FIG. 5 is a schematic cross-sectional view along the line A-B of FIG. 4.

FIG. 6 is a schematic plan view that shows contour lines of color filters provided on a color filter substrate of Embodiment 1.

FIG. 7 is a schematic cross-sectional view along the line C-D of FIG. 6.

FIG. 8 is a schematic plan view that shows contour lines of color filters provided on a color filter substrate of Reference Example 1.

FIG. 9 is a schematic cross-sectional view along the line E-F of FIG. 8.

FIG. 10 is a schematic plan view that shows a first example of the position of colors on a color filter substrate of Embodiment 2.

FIG. 11 is a schematic plan view that shows a first drawing pattern when manufacturing the first example of the color filter substrate of Embodiment 2.

FIG. 12 is a schematic plan view that shows a situation in which color mixing has occurred in some of the color filters in the first example of the color filter substrate of Embodiment 2.

FIG. 13 is a schematic plan view that shows a second example of the position of colors on the color filter substrate of Embodiment 2.

FIG. 14 is a schematic plan view that shows a first drawing pattern when manufacturing the second example of the color filter substrate of Embodiment 2.

FIG. 15 is a schematic plan view that shows a situation in which color mixing has occurred in some of the color filters in the second example of the color filter substrate of Embodiment 2.

FIG. 16 is a schematic plan view that shows a color filter in one sub-pixel when different color inks are discharged in the respective plurality of sub-pixel opening regions in one step.

FIG. 17 is a schematic plan view that shows color filters in one pixel when different color inks are discharged in the respective plurality of sub-pixel opening regions in one step.

FIG. 18 is a schematic plan view that shows color filters in which color mixing has occurred as a result of different color inks being discharged in the respective plurality of sub-pixel opening regions in one step.

FIG. 19 is a schematic plan view that shows color filters in one pixel after parts where color mixing has occurred are removed by laser.

FIG. 20 is a schematic plan view that shows color filters in one pixel after inks are discharged again after the laser removal step.

FIG. 21 is a schematic plan view that shows one example of color filters in which after the inkjet discharge is conducted in one of adjacent same color sub-pixel opening regions, inkjet discharge is conducted in the other sub-pixel opening regions in a continuous fashion.

FIG. 22 is a schematic plan view that shows one example of color filters after inkjet discharge for drawing different colored inks in a checkered pattern is conducted in one of the adjacent same color sub-pixel opening regions.

FIG. 23 is a schematic plan view that shows one example of color filters in which after inkjet discharge for drawing different color inks in a checkered pattern is conducted in one of the adjacent same color sub-pixel opening regions, a drying step is conducted so as to dry the ink drawn in the first step, and inkjet discharge is conducted in the other sub-pixel opening regions.

### DETAILED DESCRIPTION OF EMBODIMENTS

Embodiments are described below, describing in further detail the present invention with reference to the drawings, but the present invention is not limited to these embodiments.

In the present specification, wherever the word “substantially” is used when describing a shape, it signifies that the object is essentially that shape. For example, a “substantially rectangular shape” means that the entirety is essentially rectangular, but may have some protrusions or notches formed therein.

### Embodiment 1

Embodiment 1 shows one example of a color filter substrate manufactured by a manufacturing method of a color filter substrate of the present invention.

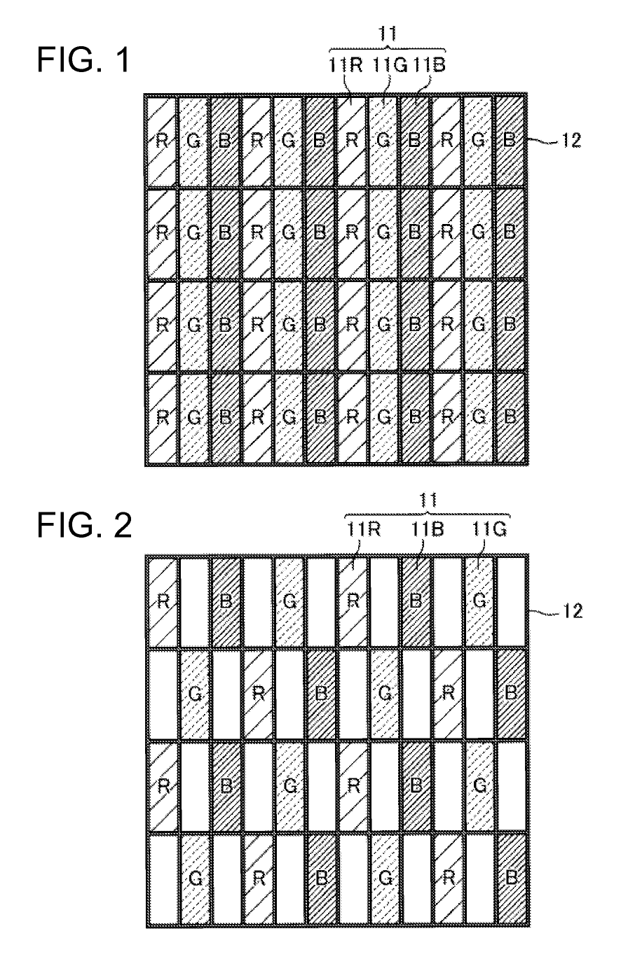

FIG. 1 is a schematic plan view that shows the position of colors on a color filter substrate of Embodiment 1. As shown in FIG. 1, in Embodiment 1, one color display surface is constituted of a plurality of pixels with three component sub-pixels of red (R), green (G), and blue (B). Each sub-pixel is substantially rectangular and arranged in a matrix in the order of red (R), green (G), and blue (B) in the horizontal direction. Also, in each red (R), green (G), and blue (B) sub-pixel, a red (R) color filter 11R, a green (G) color filter 11G, and a blue (B) color filter 11B are formed, respectively, and each color filter 11 is partitioned by a bank 12. The sub-pixels that constitute each pixel are each formed in the same pattern, and form a striped pattern such that the same color sub-pixels are formed per vertical column.

A manufacturing method of a color filter substrate of Embodiment 1 will be described in detail below.

First, a resin material containing black pigment or a metal material having light-shielding properties is formed as a film on the entire surface of a transparent substrate such as a glass substrate or a resin substrate, and photolithography is conducted to pattern the film, thus forming a grid-patterned bank 12 that partitions the area into substantially rectangular spaces. The regions surrounded by the bank 12 are sub-pixel opening regions for forming the color filters 11, and in the following steps, ink for forming the color filters is dropped into the sub-pixel opening regions. The bank 12 has the role of keeping the ink for forming the color filters in a prescribed location. Because such a bank 12 has a light-shielding function, it is also known as a black matrix.

By using a black matrix as the bank 12, it is possible to shield from light portions of the TFT substrate side as necessary, for example, thereby achieving effects such as increasing the contrast ratio of the display.

If each sub-pixel is substantially rectangular, a gentle incline is formed from the center of the sub-pixel to the short sides of the edge, and a steep incline is formed from the center of the sub-pixel to the long sides of the edge. As a result, the ink discharged into the regions partitioned by the bank 12 has a tendency to spread towards the long sides of the edge of the sub-pixel from the center, which increases the tendency for ink to overflow the bank 12 and enter the adjacent sub-pixel opening regions. If the width of the bank 12 along the long sides of the sub-pixel opening region is narrower than the width along the short sides of the sub-pixel opening region, then the probability of ink flowing into adjacent sub-pixel opening regions increases.

In order to solve this problem, Embodiment 1 has various measures to prevent the occurrence of color mixing as will be described below, and thus, such a configuration in which each sub-pixel is in a rectangular shape can be used without any problems.

Next, the ink for forming the color filter is dropped from an inkjet head into the sub-pixel opening region. If, as a pre-treatment before dropping the ink, a fluorine-containing plasma treatment is conducted on the bank 12 in order to make the surface thereof liquid-repellent, for example, the overflow of ink from the sub-pixel opening region over the bank 12 and into adjacent sub-pixel opening regions can be effectively prevented.

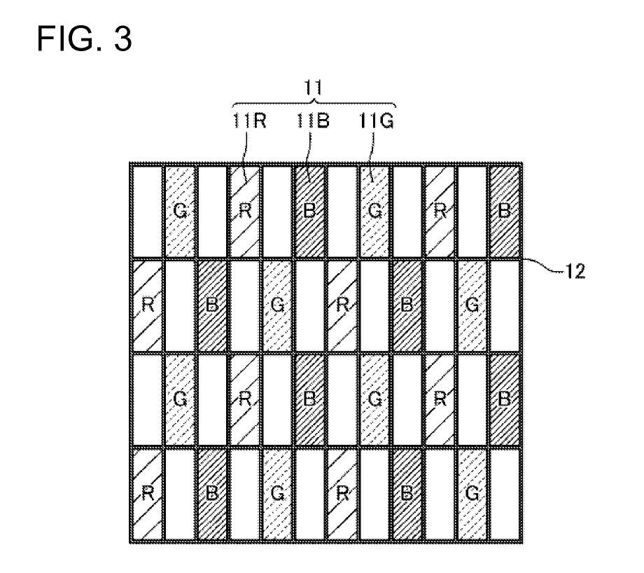

FIG. 2 is a schematic plan view that shows a first drawing pattern for when a color filter substrate of Embodiment 1 is manufactured. FIG. 3 is a schematic plan view that shows a second drawing pattern for when the color filter substrate of Embodiment 1 is manufactured. As shown in FIG. 2, in the first drawing step, the two sub-pixel opening regions adjacent to one sub-pixel opening region in the horizontal region and the two sub-pixel opening regions adjacent to the one sub-pixel opening region in the vertical direction are empty regions. Thus, a checkered pattern is formed in the first drawing step. Also, as shown in FIG. 3, in the second drawing step, ink drawing is conducted in the remaining sub-pixel opening regions, which are adjacent to the regions where the first drawing step was conducted. Thus, a checkered pattern is also formed in the second drawing step, and with the second drawing step, ink drawing is completed in all sub-pixel opening regions. The drawing method in which the regions where ink drawing is conducted form a checkered pattern is also referred to as checkered drawing below.

In the example shown in FIGS. 1 to 3, the sub-pixels of respective colors are disposed such that the three sub-pixel colors red, green, and blue form striped columns, but the types of colors and the order in which the colors are disposed are not limited in Embodiment 1.

The manufacturing method of the color filter substrate of Embodiment 1 will be described in further detail below with appropriate reference to a color filter substrate of Comparison Example 1.

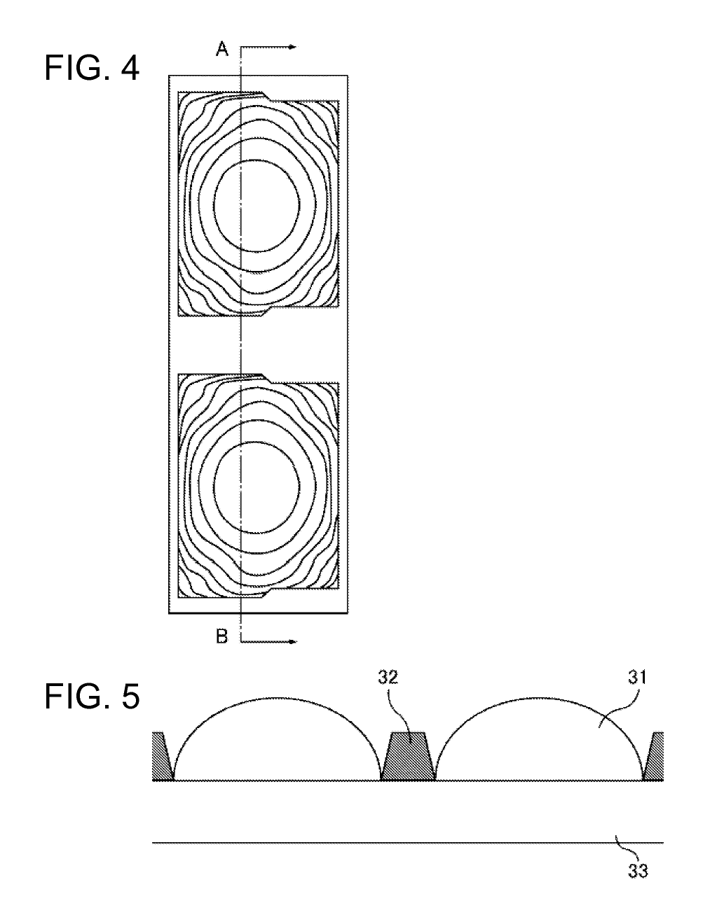

The color filter substrate of Comparison Example 1 is a color filter substrate in which color filters are formed using a method in which inks are discharged in the same step to all sub-pixel opening regions. FIG. 4 is a schematic plan view that shows contour lines of color filters provided on the color filter substrate of Comparison Example 1, and FIG. 5 is a schematic cross-sectional view along the line A-B of FIG. 4. Color filters 31 of Comparison Example 1 are formed on a substrate 33, surrounded by a bank 32. As shown in FIG. 5, the color filters in the color filter substrate of Comparison Example 1 have substantially hemispherical shapes or substantially dome shapes in which the thickness gradually increases from the edge of the sub-pixel opening region to the center. Also, as shown in FIG. 4, the contour lines of the color filters from a plan view form substantially concentric circles. Thus, in the color filter substrate of Comparison Example 1, there are few flat regions in the color filter in one sub-pixel, and the thickness thereof changes in most regions.

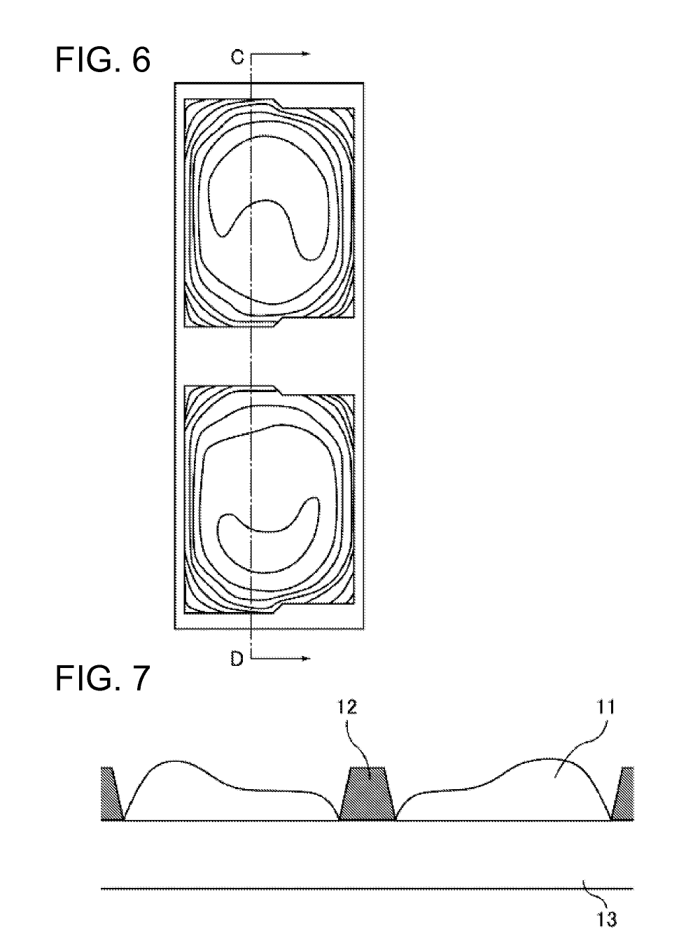

FIG. 6 is a schematic plan view that shows contour lines of the color filters provided in the color filter substrate of Embodiment 1, and FIG. 7 is a schematic cross-sectional view along the line C-D of FIG. 6. The color filters 11 in Embodiment 1 are formed on the substrate 13, surrounded by the bank 12. As shown in FIG. 7, in the color filter substrate of Embodiment 1, the thickness of the color filters decreases slightly towards the four corners of each sub-pixel opening region but most regions of the sub-pixel opening region have a flat surface. As a result, it is possible to prevent light leakage and a decrease in color purity, which occur in thin regions.

When comparing a case such as Comparison Example 1 in which drawing is conducted in one drawing step for all sub-pixel opening regions to a case such as Embodiment 1 in which drawing is conducted for all sub-pixel opening regions in two checkered drawing steps, then as shown in FIGS. 5 and 7, the case such as Embodiment 1 in which two checkered drawing steps are conducted is more advantageous in terms of the flatness of the ink. The reason is thought to be because when using checkered drawing, all adjacent sub-pixels in the horizontal direction and the vertical direction are empty regions, and the volatilized solvent from the ink formed in the drying step is less concentrated in the empty region sides than the center region of the sub-pixel opening region, which increases the surface tension of the ink towards the empty regions, which causes the ink as a whole to spread towards the empty regions. By contrast, if all sub-pixel opening regions are drawn in one drawing step, the solvent concentration is the same as the surrounding sub-pixel opening regions, which causes the surface tension to force the ink into a partial spherical shape, causing the ink to gather towards the center of the sub-pixel.

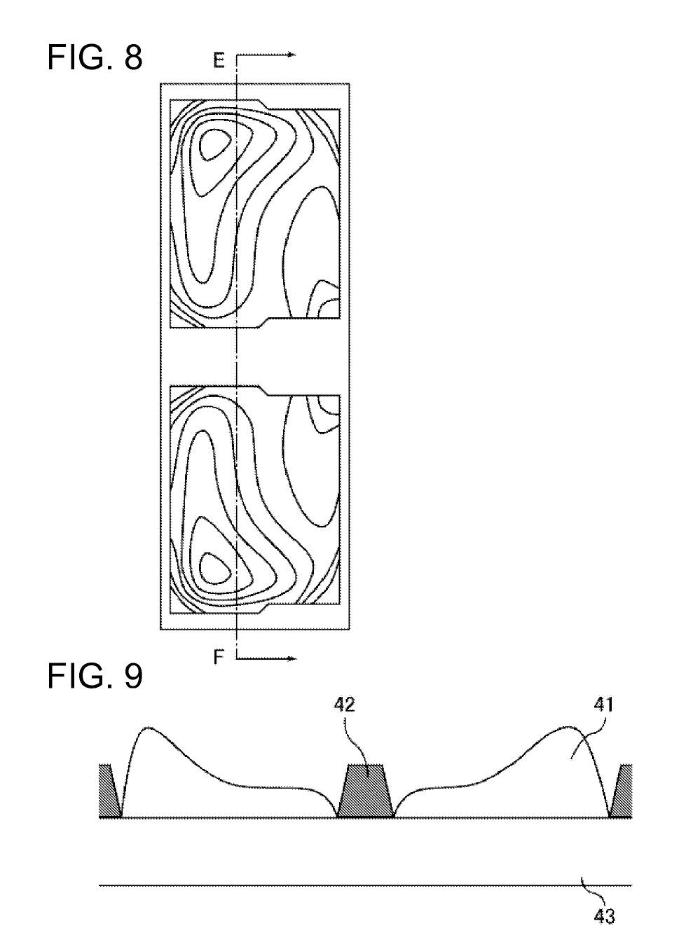

Findings concerning the presence or absence of ink in surrounding sub-pixels and the relation thereof to the variation in thickness of the ink will be described below. FIG. 8 is a schematic plan view that shows contour lines of a color filter provided on a color filter substrate of Reference Example 1, and FIG. 9 is a schematic cross-sectional view along the line E-F of FIG. 8. Color filters 41 of Reference Example 1 are formed on a substrate 43, surrounded by a bank 42. The color filter substrate of Reference Example 1 has color filters formed such that of three regions adjacent to each other in the horizontal direction one region is an empty region and ink drawing is conducted in the remaining two regions in the same step. In such a case, the ink that is dropped into the sub-pixel opening regions spreads towards the empty regions. Thus, as shown in FIG. 8, contour lines of the color filters from a plan view show that the thickness is greater towards the empty region and thinner towards the other region in which the ink drawing takes place in the same step.

Therefore, in order to prevent the ink from forming a substantially hemispherical shape or a substantially dome shape, it is effective to provide empty regions adjacent to the sub-pixel regions where ink is to be discharged, and from the perspective of making the color filter thickness as flat as possible, it is preferable that inkjet discharge be conducted such that adjacent regions are empty regions in both the horizontal direction and the vertical direction from the sub-pixel region where ink is to be discharged.

After the first drawing step is conducted, it is preferable that a drying step be conducted. In the drying step, heating, vacuum drying, or the like is conducted, for example, to dry the ink to a sufficient degree such that the ink is no longer fluid. Drying is particularly efficient if materials for heat polymerization are used in the ink. In Patent Document 2, the ink drawing was divided into a plurality of steps, and the substrate was left as is for a prescribed amount of time after the first drawing step to allow the ink that has risen onto the bank to flow into the sub-pixel opening region, relying on the liquid-repellence properties of the bank surface. However, if the ink is not sufficiently dry, the problem of color mixing occurs when ink enters in the second ink drawing step. In particular, the volatilized solvent resulting from the first ink drawing step decreases the liquid-repellence of the bank, which means that even if sufficient liquid-repellence was attained during the first drawing step, the bank does not necessarily have sufficient liquid-repellence during the second drawing step. Thus, it is ideal for the drying step to be conducted in order to dry the ink to a sufficient degree. Because the liquid-repellence of the bank surface decreases in the first ink drawing step, it is more preferable that liquid-repellence treatment such as a fluorine-containing plasma treatment be conducted again on the bank after the drying step. Also, it is preferable that hydrophilic treatment be conducted on the substrate surface.

Next, a laser removal step is conducted on ink that has flowed into adjacent sub-pixel opening regions as a result of the first drawing step. As stated above, even if the laser removal step is conducted, it is difficult to remove all of the ink, and a remaining margin is left over along the inner edges of the bank. However, by removing as much of this ink as possible, it is possible to mitigate color mixing to a greater degree.

When conducting laser treatment, first, an inspection is conducted to detect the presence or absence of defects after the first drawing step, and removal treatment is conducted on dry ink selectively in sub-pixels where a defect has occurred. Lasers that can be used include a YAG (yttrium aluminum garnet) laser, for example. Such a laser removal step may be conducted for defects other than color mixing such as a defect due to contamination.

Then, an ink discharge step is conducted in the remaining sub-pixel opening regions by the second ink drawing step, which completes all color filters.

Next, a step of forming a common electrode on the color filters, a step of forming an alignment film on the common electrode, and the like are conducted, and the color filter substrate is completed. The completed color filter substrate is used in a liquid crystal display panel by being bonded to a separately manufactured TFT substrate, with a liquid crystal layer interposed therebetween. Thus, the liquid crystal display panel has a pair of substrates constituted of a color filter substrate and a TFT substrate, and a liquid crystal layer is sandwiched between the pair of substrates. Also, as necessary, optical films such as retardation films and polarizing plates are bonded onto both surfaces of the liquid crystal panel, and a backlight or the like is disposed on the liquid crystal display panel side, thus completing the liquid crystal display device.

### Embodiment 2

Embodiment 2 shows one example of a color filter substrate manufactured by a manufacturing method of a color filter substrate of the present invention. In Embodiment 2, the color filter substrate is similar to the color filter substrate of Embodiment 1 except that the number of colors for the color filters differs.

In Embodiment 2, the color filters provided on the color filter substrate include not only the three colors red (R), green (G), and blue (B), but also magenta (M), cyan (C), and yellow (Y) to form a total of six colors, but the types of colors and their positional orders in Embodiment 2 are not limited, and other colors may be used. For example, a combination in which one yellow (Y) and two cyans (C) are provided and arranged in the order of cyan (C), cyan (C), and yellow (Y) may be used. Magenta (M), cyan (C), and yellow (Y) are complementary colors of red (R), blue (B), and green (G), respectively.

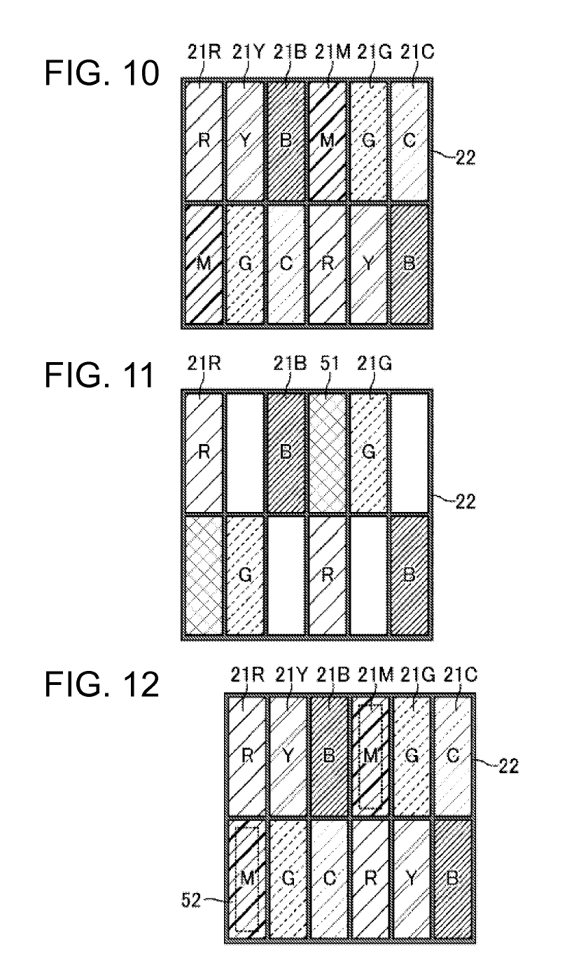

FIG. 10 is a schematic plan view that shows a first example of the positions of the colors in the color filter substrate of Embodiment 2. As shown in FIG. 10, red (R), green (G), and blue (B) are each arranged so as not to be adjacent to each other. Magenta (M), cyan (C), and yellow (Y) are also each arranged so as not to be adjacent to each other. Red and magenta, green and yellow, and blue and cyan are respectively adjacent to each other in the vertical direction and this combination is repeated.

FIG. 11 is a schematic plan view that shows a first drawing pattern for when the first example of the color filter substrate of Embodiment 2 is manufactured. FIG. 12 is a schematic plan view that shows a situation in which color mixing has occurred in some color filters in the first example of the color filter substrate of Embodiment 2. As shown in FIG. 11, in the first drawing step, two sub-pixel opening regions adjacent in the horizontal direction to a sub-pixel opening region where ink drawing is conducted, and two sub-pixel opening regions adjacent in the vertical direction thereto are empty regions. Thus, the pattern formed in the first drawing step is a checkered pattern. The colors used in the first drawing step are red (R), green (G), and blue (B). In the second drawing step, ink drawing is conducted in the remaining sub-pixel opening regions adjacent to the regions where the first drawing step was conducted. Thus, the pattern formed in the second drawing step is also a checkered pattern, and with the second drawing step, all sub-pixel opening regions are filled with ink. The colors used in the second drawing step are magenta (M), cyan (C), and yellow (Y).

As shown in FIG. 11, in the first drawing step, ink flows into some of the blank regions, and as a result, as shown in FIG. 12, some of the color filters have color mixing, but in Embodiment 2, a drying step in which the ink is dried to a sufficient degree, and a removal step that removes the ink by laser are conducted, and thus, compared to a situation in which ink is mixed without being sufficiently dry, the color mixing does not stand out as much.

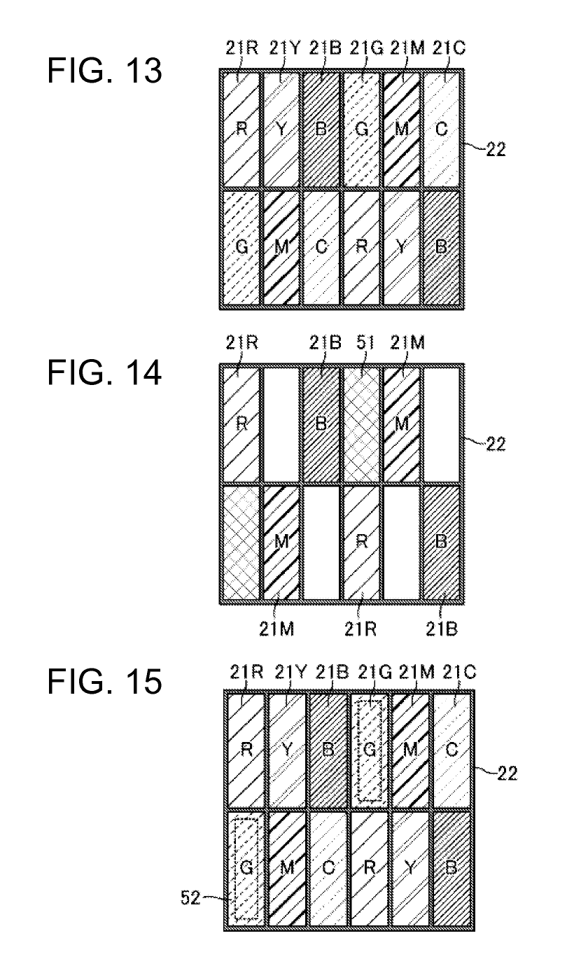

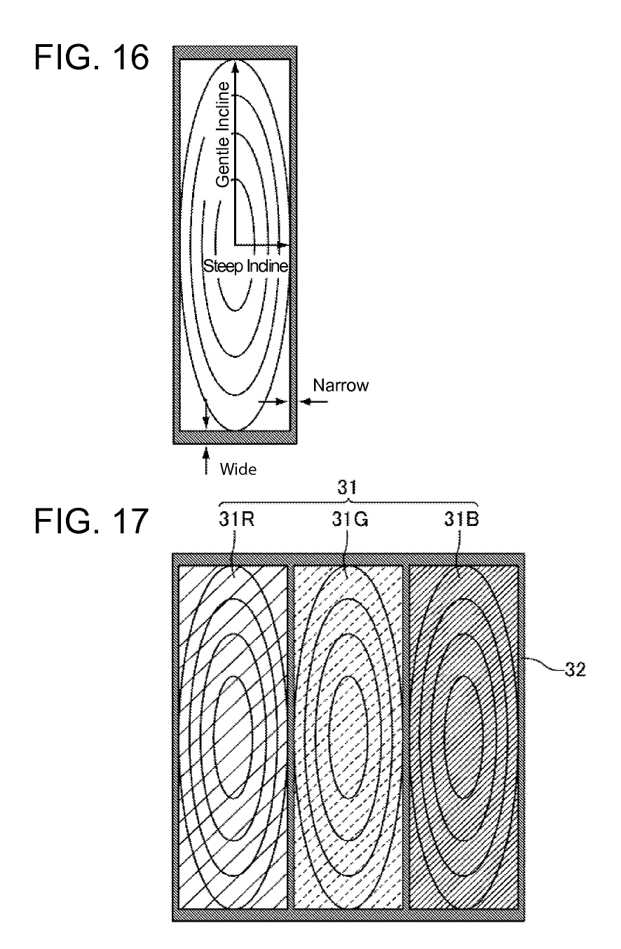

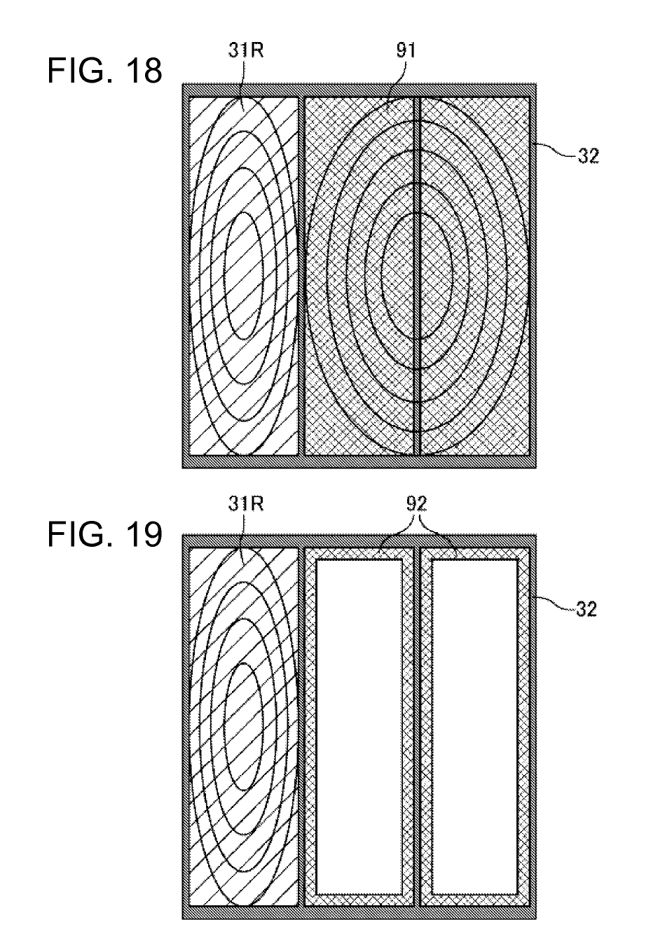

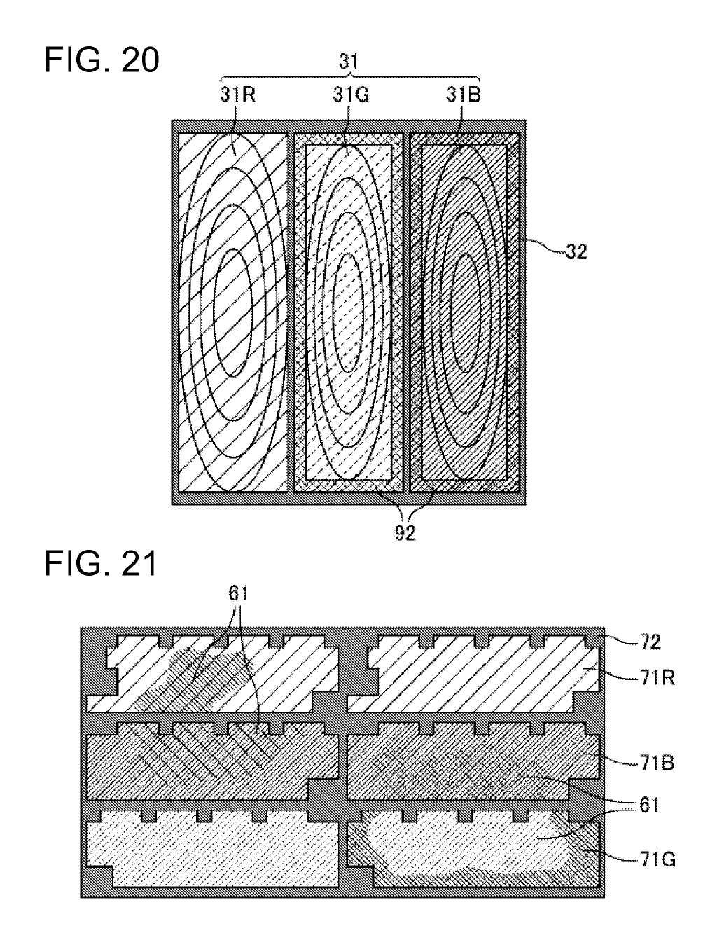

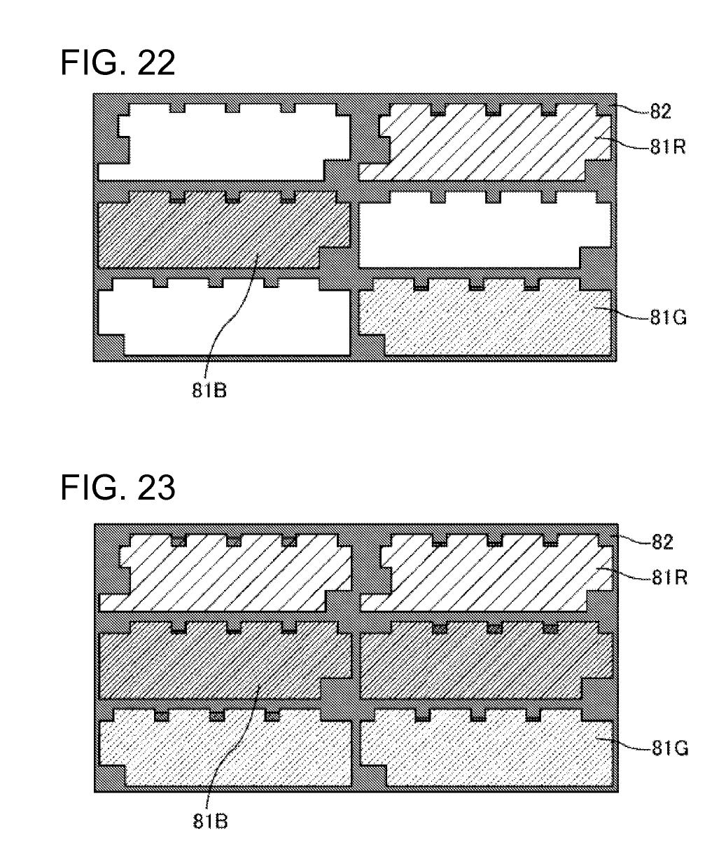

FIG. 13 is a schematic plan view that shows color positions for a second example of the color filter substrate of Embodiment 2. As shown in FIG. 13, red (R), blue (B), and magenta (M) are formed so as not to be adjacent to each other. Also, green (G), cyan (C), and yellow (Y) are formed so as not to be adjacent to each other. Red and green, magenta and yellow, and blue and cyan are respectively disposed adjacent to each other in the vertical direction, and this combination is repeated.

FIG. 14 is a schematic plan view that shows the first drawing pattern for when the second example of the color filter substrate of Embodiment 2 is manufactured. FIG. 15 is a schematic plan view that shows a situation in which color mixing has occurred in some color filters in the second example of the color filter substrate of Embodiment 2. As shown in FIG. 14, in the first drawing step, two sub-pixel opening regions adjacent in the horizontal direction to a sub-pixel opening region where ink drawing is conducted, and two sub-pixel opening regions adjacent in the vertical direction thereto are empty regions. Thus, the pattern formed in the first drawing step is a checkered pattern. The colors used in the first drawing step are red (R), blue (B), and magenta (M). In the second drawing step, ink drawing is conducted in the remaining sub-pixel opening regions adjacent to the regions where the first drawing step was conducted. Thus, the pattern formed in the second drawing step is also a checkered pattern, and with the second drawing step, all sub-pixel opening regions are filled with ink. The colors used in the second drawing step are green (G), cyan (C), and yellow (Y).

As shown in FIG. 14, in the first drawing step, regions 51 in which ink has flowed into some of the empty regions are formed in the first drawing step. As a result, as shown in FIG. 15, regions 52 in which different colored inks overlap in a portion of the color filter are formed, but in Embodiment 2, a drying step in which the ink is dried to a sufficient degree, and a removal step that removes the ink by laser are conducted, and thus, compared to a situation in which ink has mixed without being sufficiently dry, the color mixing does not stand out as much.

However, in terms of display quality, the second example of Embodiment 2 is better than the first example. This is because, in the second example, a color combination is chosen in which any color mixing that occurs does not stand out.

As stated above, even if checkered drawing is conducted, when ink is discharged, ink sometimes enters the adjacent sub-pixel opening regions. While it is possible to have the ink not stand out as much by repairing this with the laser removal step and conducting a drying step, it is difficult to adjust the amount of ink discharged for specific sub-pixel opening regions when all drawing steps are done on the same surface. Also, the drawn ink spreads in the part removed by the laser, and in a region of the sub-pixel opening region other than the region where a remaining margin is present, i.e., an actual opening region, the average thickness of the ink increases, which means those sub-pixels sometimes appear as black dots. By using a combination of colors such that when color mixing occurs differences in color or brightness are difficult to perceive, the display quality can be more effectively increased.

Specifically, because regions with a low transmittance are more susceptible to change than regions with a high transmittance, when red (R), blue (B), and magenta (M), which have a low transmittance to begin with, are drawn in the second drawing step, evidence of having repaired defects using a laser can be seen more easily. Thus, when forming color filters using a plurality of drawing steps, in the first drawing step, red (R), blue (B), and magenta (M), which have a lower transmittance, should be drawn, and in the second drawing step, green (G), cyan (C), and yellow (Y), which have a higher transmittance, should be drawn, which allows higher quality repairs to be performed.

In the second example of the color filter substrate of Embodiment 2, when comparing the transmittance of ink in regions with a remaining margin to the transmittance of ink in parts where ink has been drawn again after conducting laser removal, the ink in the region with the remaining margin has a lower transmittance.

The present application claims priority to Patent Application No. 2010-159911 filed in Japan on Jul. 14, 2010 under the Paris Convention and provisions of national law in a designated State. The entire contents of which are hereby incorporated by reference.

### DESCRIPTION OF REFERENCE CHARACTERS

11, 31, 41 color filter

11R, 21R, 31R, 71R, 81R red color filter

11G, 21G, 31G, 71G, 81G green color filter

11B, 21B, 31B, 71B, 81B blue color filter

21Y yellow color filter

21M magenta color filter

21C cyan color filter

12, 22, 32, 42, 72, 82 bank (black matrix)

13, 33, 43 substrate

51 region where ink has flowed into empty region

52 region where different inks overlap

61, 91 part where color mixing has occurred

92 remaining margin

1. A manufacturing method for a color filter substrate that has color filters of a plurality of colors arranged in a matrix with a bank therebetween, comprising:
a first inkjet step in which ink is discharged to at least one region of a plurality of regions partitioned by the bank, and in which ink is not discharged to any region adjacent to said at least one region in the horizontal direction or the vertical direction; and
a second inkjet step in which ink is discharged to at least one region out of the plurality of regions partitioned by the bank where ink was not discharged in the first inkjet step.

2. A manufacturing method for a color filter substrate that has color filters of a plurality of colors arranged in a matrix with a bank therebetween, comprising:
a first inkjet step in which ink is discharged to at least one region of a plurality of regions partitioned by the bank;
a drying step in which ink is dried after the first inkjet step; and
a second inkjet step in which ink is discharged to at least one region out of the plurality of regions partitioned by the bank where ink was not discharged in the first inkjet step.

3. A manufacturing method for a color filter substrate that has color filters of a plurality of colors arranged in a matrix with a bank therebetween, comprising:
a first inkjet step in which ink is discharged to at least one region of a plurality of regions partitioned by the bank;
a liquid-repellence step in which liquid-repellence treatment is conducted on a surface of the bank that surrounds the ink after the first inkjet step; and
a second inkjet step in which ink is discharged to at least one region out of the plurality of regions partitioned by the bank where ink was not discharged in the first inkjet step.

4. The manufacturing method for a color filter substrate according to claim 3, wherein the first inkjet step is a step in which ink is not discharged to any region adjacent to said at least one region in the horizontal direction or the vertical direction.

5. The manufacturing method for a color filter substrate according to claim 4, wherein the first inkjet step is a step in which ink is discharged in a checkered pattern.

6. The manufacturing method for a color filter substrate according to claim 4, wherein the second inkjet step is a step in which ink is discharged in a checkered pattern.

7. The manufacturing method for a color filter substrate according to claim 3, comprising, between the first inkjet step and the second inkjet step, a drying step of drying the ink after the first inkjet step.

8. The manufacturing method for a color filter substrate according to claim 1, comprising, between the first inkjet step and the second inkjet step, a liquid-repellence step of conducting a liquid-repellence treatment on a surface of the bank.

9. The manufacturing method for a color filter substrate according to claim 7, wherein the drying step is a step of applying heat to polymerize a material included in the ink.

10. The manufacturing method for a color filter substrate according to claim 4, wherein a region where the second inkjet step is conducted is at least one region adjacent to a region where the first inkjet step is conducted.

11. The manufacturing method for a color filter substrate according to claim 3, comprising, between the first inkjet step and the second inkjet step, a repair step of removing the ink by laser after the first inkjet step.

12. The manufacturing method for a color filter substrate according to claim 3, wherein a transmittance of a color of a color filter formed in the first inkjet step is less than a transmittance of a color of a color filter formed in the second inkjet step.

13. The manufacturing method for a color filter substrate according to claim 3, comprising a hydrophilic step of conducting hydrophilic treatment on a surface where ink is to land before the second inkjet step.
